(19) United States
(12) Patent Application Publication
(10) Pub. No.: US 2013/0213274 A1
(43) Pub. Date: Aug. 22, 2013

(54) CEMENT COMPOSITION, METHOD FOR PRODUCING MIXED MATERIAL, AND METHOD FOR PRODUCING CEMENT COMPOSITION

(71) Applicants: Keishiro Iriya, Chiba (JP); Akira Shimmura, Kanagawa (JP); Nobufumi Takeda, Saitama (JP); Toshimitsu Kobayashi, Tokyo (JP); Kenichi Ichise, Saitama (JP)

(72) Inventors: Keishiro Iriya, Chiba (JP); Akira Shimmura, Kanagawa (JP); Nobufumi Takeda, Saitama (JP); Toshimitsu Kobayashi, Tokyo (JP); Kenichi Ichise, Saitama (JP)

(73) Assignee: OBAYASHI CORPORATION, Minato-ku, Tokyo (JP)

(21) Appl. No.: 13/819,277

(22) PCT Filed: Jul. 15, 2011
(86) PCT No.: PCT/JP2011/066198

§ 371 Date: Apr. 26, 2013

(30) Foreign Application Priority Data
Aug. 26, 2010 (JP) 2010-190103
Oct. 15, 2010 (JP) 2010-232963

(51) Int. Cl. C04B 7/14; B28C 5/00

(52) U.S. Cl. CPC C04B 7/14; B28C 5/003
USPC 106/707; 366/2

(57) ABSTRACT

The present invention provides cement composition including 100 parts by weight of binder (B) including, 5-30 parts by weight of cement, 0-20 parts by weight of silica fume, 0-50 parts by weight of fly ash, and 42-75 parts by weight of blast furnace slag; water (W) equivalent to 80-185 kg/m³ of water content per unit volume of concrete; aggregate (A); and chemical admixture for concrete (AD).

### TECHNICAL FIELD

The present invention relates to cement composition, method for producing mixed material and method for producing cement composition.

### BACKGROUND ART

In general, cement composition is produced by mixing several materials such as water, cement, aggregate, admixture for concrete and the like (for example, refer to Japanese Patent No. 3844457 Specification). Of the above, cement is a material that emits a large amount of carbon dioxide (CO₂) when producing cement composition. And from an environmental viewpoint, it can hardly be said that cement composition is a material that takes into account the burden on the environment. Therefore mineral admixture for concrete, such as blast furnace slag and fly ash can be added as an alternate to the reduced cement so that the strength of the cement composition would develop even when cement usage is reduced.

### CITATION LIST

### Patent Literature

[PTL 1] Japanese Patent No. 3844457 Specification

### SUMMARY OF INVENTION

### Technical Problem

Carbon dioxide emissions during cement composition production process can be cut back by reducing the amount of cement and increasing the amount of mineral admixture for concrete such as blast furnace slag and fly ash as an alternate to cement. In this case however, there is a fear that the strength of cement composition would decrease by reducing the amount of cement. Further in the case of reducing the amount of cement usage and using mineral admixture for concrete such as blast furnace slag and fly ash as an alternate to cement, there is a fear that the amount of material would vary greatly among several materials which are mixed. For example, there is a case where the amount of a specific material is extremely small compared to the amount of other materials. In such a case, there is a fear that each of the materials would not be homogeneously mixed when a wide variety of materials are mixed at a time. And this presents a problem of a possibility that appropriate strength would not develop when producing cement composition.

The present invention has been made in view of the above problem and an objective thereof is to provide cement composition that is capable of both reducing the amount of carbon dioxide emissions and developing high strength and another objective thereof is to provide a method for producing mixed material and a method for producing cement composition that is suitable for producing cement composition capable of reducing carbon dioxide emissions, developing high strength and securing quality as well.

### Solution to Problem

An aspect of the present invention for achieving an objective above is cement composition that includes 100 parts by weight of binder (B) including, 5-30 parts by weight of cement, 0-20 parts by weight of silica fume, 0-50 parts by weight of fly ash, and 42-75 parts by weight of blast furnace slag; water (W) equivalent to 80-185 kg/m³ of water content per unit volume of concrete; aggregate (A); and chemical admixture for concrete (AD).

With such cement composition, carbon dioxide emissions can be reduced and high strength can be developed as well.

It is preferable that the water (W) of the water content per unit volume of concrete in the cement composition is 100-150 kg/m³.

With such cement composition, carbon dioxide emissions can be further reduced and high strength can be developed as well.

It is preferable that the cement content per unit volume of concrete in the cement composition is 18-89 kg/m³.

With such cement composition, carbon dioxide emissions can be further reduced and high strength can be developed as well owing to the cement content per unit volume of concrete within the entire cement composition being small.

It is preferable that the cement composition includes 5-20 parts by weight of the above cement and 5-50 parts by weight of the above fly ash.

With such cement composition, the balance between reduction of carbon dioxide emissions and development of high strength can be further improved.

It is preferable that the cement composition includes 5-15 parts by weight of the above cement.

With such cement composition, carbon dioxide emissions can be much more reduced while further improving the balance between carbon dioxide emissions and development of high strength.

It is preferable that the cement composition has a water-binder ratio (W/B), being the weight ratio of the above water (W) to the above binder (B), greater than or equal to 35% and less than or equal to 45%.

It is preferable that the 28-day standard cured compressive strength ranges from 16 N/mm² to 70 N/mm² (16-70 MPa).

It is preferable that the cement composition includes at least one or more types of additive selected from a group consisting of alkaline component, gypsum, tri-isopropanolamine, and limestone powder. It is preferable that the above alkaline component in the cement composition is calcium hydroxide. And it is preferable that the weight ratio of the above calcium hydroxide to the above binder (B) is less than 0.1%.

It is preferable that the above gypsum in the cement composition is natural anhydrite. And it is preferable that the weight ratio of the above gypsum to the above binder (B) is greater than or equal to 1.2% and less than or equal to 6.0%. Further, it is preferable that the weight ratio of the above limestone powder to the above binder (B) is greater than or equal to 0.3% and less than or equal to 108.0%. And it is preferable that the weight ratio of the above tri-isopropanolamine to the binder (B) is less than 1.0%.

It is preferable that the above silica fume in the cement composition is the silica fume derived from zirconia. And it is preferable that the above fly ash is the fly ash that satisfies the values which are specified for type-I fly ash of JIS (Japan Industrial Standard) A 6201. Further, it is preferable that the above cement is sulfate resistant portland cement. According to such cement composition, the fluidity in the fresh property of the cement composition can be improved.

An aspect of the present invention for achieving another objective above is a method for producing mixed material including producing 100 parts by weight of mixed material by mixing 5-30 parts by weight of cement, 0-20 parts by weight of silica fume, 0-50 parts by weight of fly ash, and 42-75 parts by weight of blast furnace slag.

With such method for producing mixed material, mixed material can be mixed with a proportion appropriate for producing cement composition capable of reducing carbon dioxide emissions, developing high strength and securing quality as well, to be used as a binder. And the mixed binder includes cement, silica fume, fly ash and blast furnace slag of amounts appropriate for producing cement composition capable of reducing carbon dioxide emissions, developing high strength and securing quality as well, therefore containers such as silos for separately storing each material are not required. For this reason, storage space and the cost can be saved. Further, cement, silica fume, fly ash and blast furnace slag can be premixed at plants and the like. Therefore, materials can be accurately measured by use of equipment at the plants and the like allowing provision of binders that are versatile, that secures high quality and retains uniform quality. Additionally, the use of premixed binders makes it possible to reduce the mixing time at ready-mixed concrete plants. And further, mixed material suitable for not only as binders but also as, for example, mixed material to be mixed with soil for soil improvement can be produced.

An aspect of the present invention is a method for producing mixed material including producing mixed material by mixing 5-30 parts by weight of cement, and at least one type of material selected from three types of material being 0-20 parts by weight of silica fume, 0-50 parts by weight of fly ash and 42-75 parts by weight of blast furnace slag.

With such method for producing mixed material, it is possible to produce mixed material that includes at least one type of material selected from silica fume, fly ash and blast furnace slag, and that can be used as a binder suitable for producing cement composition capable of reducing carbon dioxide emissions, developing high strength and securing quality as well. And since the mixed material includes cement and at least one type of material selected from silica fume, fly ash and blast furnace slag of an amount appropriate for producing cement composition capable of reducing carbon dioxide emissions, developing high strength and securing quality as well, containers such as silos for separately storing all the materials are not required. Therefore, storage space and the cost can be saved by reducing the containers to be used. Further, cement can be premixed with at least one type of material selected from silica fume, fly ash and blast furnace slag at plants and the like. For such reason, materials can be accurately measured by use of equipment at the plants and the like allowing provision of mixed material that is versatile, that secures high quality and retains uniform quality compared with the case where all the materials are mixed at ready-mixed concrete plants. Additionally, the use of premixed binders makes it possible to reduce the mixing time at ready-mixed concrete plants. And further, binders suitable as, for example, mixed material to be mixed with soil for soil improvement can be produced.

It is preferable that mixed material produced by such method for producing mixed material, is mixed with aggregate.

With such method for producing mixed material, it is possible to provide mixed material having mixed therein binders and aggregate, suitable for producing cement composition capable of reducing carbon dioxide emissions, developing high strength and securing quality as well.

An aspect of the present invention is a method for producing mixed material having at least one type of material selected from four types of material being 5-30 parts by weight of cement, 0-20 parts by weight of silica fume, 0-50 parts by weight of fly ash, and 42-75 parts by weight of blast furnace slag including premixing at least one type of material with aggregate when the mixed material includes the one type of material selected from the four types of materials; and premixing the material whose amount to be mixed is smaller of two or more types of material with the material whose amount is larger or with the aggregate, when the mixed material includes the two or more types of the material selected from the four types of material.

With such method for producing mixed material, at least two types of material selected from the four types of material being 5-30 parts by weight of cement, 0-20 parts by weight of silica fume, 0-50 parts by weight of fly ash, 42-75 parts by weight of blast furnace slag and aggregate in a mixed state, can be mixed with other materials. And since the mixed material includes cement and at least two types of material selected from silica fume, fly ash, blast furnace slag, and aggregate of amounts appropriate for producing cement composition capable of reducing carbon dioxide emissions, developing high strength and securing quality as well, containers such as silos for separately storing each of the materials are not required. Therefore, storage space and the cost can be saved. Further, at least one type of material selected from cement, silica fume, fly ash and blast furnace slag can be premixed with aggregate at plants and the like. For such reason, materials can be accurately measured by use of equipment at the plants and the like allowing provision of mixed material that is versatile, that secures high quality and retains uniform quality compared with the case where all the materials are mixed at ready-mixed concrete plants.

Further, when the mixed material to be produced includes one type of material selected from the four types of material, the one type of material and aggregate are premixed so that even if the one type of material is of an extremely small amount, premixing with the large amount of aggregate to be mixed allows homogeneous mixing. And when the mixed material to be produced includes two or more types of material selected from the four types of material, the material, of the two or more types of material, of a smaller amount to be mixed is premixed with the material of a greater amount to be mixed or with the aggregate, so that even if the two types of material to be mixed includes material of an extremely small amount, the material of an extremely small amount is premixed with the material to be mixed of a large amount or a large amount of aggregate to be mixed, allowing the material of an extremely small amount to be mixed homogeneously. In this case, it is preferable that the aggregate to be mixed with the one type of material is fine aggregate. And when producing concrete by use of such mixed material, the use of already mixed mixed material can reduce the mixing time at ready-mixed concrete plants. Furthermore, such mixed material can be produced as mixed material suitable for, for example, mixed material to be mixed with soil for soil improvement.

It is preferable that the cement is 5-20 parts by weight and the fly ash is 5-50 parts by weight in the method for producing mixed material.

With such method for producing mixed material, since cement is 5-20 parts by weight and fly ash is 5-50 parts by weight, it allows production of mixed material usable as more appropriate binders for producing cement composition capable of reducing carbon dioxide emissions, developing high strength and securing quality as well.

It is preferable that the cement is 5-15 parts by weight in the method for producing mixed material.

With such method for producing mixed material, since the cement is 5-15 parts by weight, it allows production of mixed material usable as furthermore appropriate binders for producing cement composition capable of reducing carbon dioxide emissions, developing high strength and securing quality as well.

An aspect of the present invention is a method for producing mixed material including mixing at least two types of material selected from four types of material being 5-30 parts by weight of cement, 0-20 parts by weight of silica fume, 0-50 parts by weight of fly ash and 42-75 parts by weight of blast furnace slag.

With such method for producing mixed material, it allows the provision of mixed material having mixed therein at least two types of material selected from four types of material being, 5-30 parts by weight of cement, 0-20 parts by weight of silica fume, 0-50 parts by weight of fly ash and 42-75 parts by weight of blast furnace slag.

An aspect of the present invention is a method for producing mixed material including mixing at least two types of material selected from three types of material being 0-20 parts by weight of silica fume, 0-50 parts by weight of fly ash and 42-75 parts by weight of blast furnace slag.

With such method for producing mixed material, it allows the provision of mixed material having mixed therein at least two types of material selected from three types of material being, 0-20 parts by weight of silica fume, 0-50 parts by weight of fly ash and 42-75 parts by weight of blast furnace slag. Such mixed material is also suitable as, for example, mixed material to be mixed with soil for soil improvement. And since the mixed material includes at least two types of material selected from silica fume, fly ash and blast furnace slag of amounts appropriate for producing cement composition capable of reducing carbon dioxide emissions, developing high strength and securing quality as well, containers such as silos for separately storing all the materials are not required. Therefore, storage space and the cost can be saved. Further, since at least two types of material selected from silica fume, fly ash and blast furnace slag are mixed, at least the two types of material can be premixed at plants and the like. For such reason, materials can be accurately measured by use of equipment at the plants and the like allowing provision of mixed material that is versatile, that secures high quality and retains uniform quality compared with the case where all the materials are mixed at ready-mixed concrete plants. Further, the mixing time at ready-mixed concrete plants can be reduced due to the use of premixed mixed material. Furthermore, mixed material capable of, for example, being mixed with soil together with cement for soil improvement can be produced.

An aspect of the present invention is a method for producing cement composition including mixing mixed material produced by the above method for producing mixed material, and water (W).

With such method for producing cement composition, cement composition capable of reducing carbon dioxide emissions, developing high strength and securing quality as well, can be easily produced by merely mixing binders produced by premixing, and water.

It is preferable that the water (W) equivalent to 80-185 kg/m³ of water content per unit volume of concrete is mixed in the method for producing cement composition.

With such method for producing cement composition, cement composition that further reduces carbon dioxide emissions and further develops high strength as well can be produced.

It is preferable that the water (W) is 100-150 kg/m³ of water content per unit volume of concrete in the method for producing cement composition.

With such method for producing cement composition, cement composition that furthermore reduces carbon dioxide emissions and furthermore develops high strength as well can be produced.

It is preferable that cement content per unit volume of concrete is 18-89 kg/m³ in the method for producing cement composition.

With such method for producing cement composition, cement composition that furthermore reduces carbon dioxide emissions and furthermore develops high strength as well can be produced, since the cement content per unit volume of concrete within the entire cement composition is small in the method for producing cement composition.

### Advantageous Effects of Invention

With the present invention, cement composition capable of reducing carbon dioxide emissions and developing high strength as well, and a method for producing mixed material and a method for producing cement composition appropriate for producing cement composition capable of reducing carbon dioxide emissions, developing high strength and securing quality as well, can be provided.

### BRIEF DESCRIPTION OF DRAWINGS

FIG. 1 shows a diagram for explaining the method for producing mixed material and the method for producing cement composition according to the present invention.

### DESCRIPTION OF EMBODIMENTS

Examples of the present invention will be discussed hereunder in further detail.

In an example of the present invention, description will be given on the concrete composed of water, cement, fine aggregate, coarse aggregate and the like, as cement composition of the present invention, capable of both reducing carbon dioxide emissions and developing high strength as well.

In another example of the present invention, description will be given on the concrete composed of water, cement, fine aggregate, coarse aggregate and the like, being a cement composition produced by a method of producing mixed material and a method for producing cement composition appropriate for producing cement composition of the present invention, capable of reducing carbon dioxide emissions, developing high strength and securing quality as well. Here at first, description will be given on concrete capable of reducing carbon dioxide emissions and developing high strength as well.

With the concrete of an example of the present invention, usage of cement that emits a large amount of carbon dioxide was reduced and mineral admixture for concrete (binders) that emits lesser amounts of carbon dioxide was used as alternative material to cement. In this way, carbon dioxide emissions can be reduced when producing concrete by reducing the usage of cement as much as possible. However, there is a fear that concrete strength would decrease due to the reduction of cement usage.

Given these circumstances, in the present examples, concrete which has the material composition taking the balance between reduction of carbon dioxide emission, fresh properties of concrete and development of strength into account, was developed through studies given hereunder. In the following description, samples of concrete, on which tests were carried out, whose mix ratio and the like differ from each other are indicated by sample numbers (Sample No.) which correspond to the conditions and results of each sample in the tables.

### (1) Study on the Rate of Binder Use

As mentioned above, the usage of cement that emits large amounts of carbon dioxide was reduced as much as possible and binders that emit lesser amounts of carbon dioxide were increased. In the present examples, blast furnace slag, fly ash and silica fume were used as binders. Note that, since the binders affect the strength developed and the fresh properties of concrete, as well as carbon dioxide emission, the balance of the usage ratio between cement, blast furnace slag, fly ash, silica fume, and water was studied.

In the present examples, studies were made on ordinary portland cement and sulfate resistant portland cement as cement, studies were made on silica fume derived from ferrosilicon and silica fume derived from zirconia as silica fume, and studies were made on type-I fly ash and type-II fly ash specified by JIS A 6201 as fly ash.

### (2) Study on Additive

Studies were made on mixing of alkaline component, gypsum, strength increaser, and limestone powder in order to improve the strength of concrete.

Alkaline component is used to accelerate the hardening of slag, fly ash and the like by the stimulation of alkaline. Calcium hydroxide solution simulating sludge water was used as the alkaline component in the present examples.

Additionally, although there are dihydrate gypsum, hemihydrate gypsum and anhydride as gypsum, anhydride was used in the present examples. Further, although there is anhydride as a by-product (industrial by-product) when producing fluorine, naturally produced anhydride and the like, natural anhydride was used in the present examples. Note that, gypsum is a part of the aforementioned blast furnace slag.

Further, a strength increaser including tri-isopropanolamine as its principal component was used in the present examples.

Furthermore, studies on mixing of chemical admixture for concrete (AD) were made. As chemical admixture for concrete (AD), there are, for example, water reducing agent, high-range air-entraining water reducing agent (superplasticizer), air-entraining water reducing agent, and high-range water reducing agent.

### (3) Study on the Amount of Water Usage

Reducing the amount of binders, including cement, is effective for reducing carbon dioxide emissions. However, the strength of concrete depends on the water-binder ratio (weight ratio of the water to the binder). Therefore, studies were also made on amount of water (water content per unit volume of concrete) in the case where the amount of binders was reduced.

### Examples

Although description on the present invention will be given in further detail with examples, the present invention is not limited to such examples.

### <Materials Used>

Table 1 shows specific materials used in the present examples.

TABLE 1

| ITEM | SYMBOL | PRODUCT NAME | DENSITY |
|---|---|---|---|
| WATER | W1 | TAP WATER | 1.00 |
| | W2 | SATURATED CALCIUM | 1.00 |
| | | HYDROXIDE SOLUTION 0.13% | |
| | W3 | SUPERNATANT WATER (SLUDGE WATER) | 1.00 |
| BINDER | OPC | ORDINARY PORTLAND CEMENT | 3.16 |
| | SR | SULFATE RESISTANT PORTLAND CEMENT | 3.20 |
| | SF1 | SILICA FUME (ELKEM-EGYPT) | 2.20 |
| | | | (2.12) |
| | SF2 | SILICA FUME (ZIRCONIA) | 2.23 |
| | FA1 | TYPE-II FLY ASH (JISA6201) | 2.25 |
| | FA2 | TYPE-I FLY ASH (JISA6201) | 2.40 |
| | GGBS | GROUND GRANULATED | 2.90 |
| | | BLAST FURNACE SLAG | |
| | CaSO₄ | ANHYDRITE | 2.90 |
| MINERAL | LSP | LIMESTONE POWDER | 2.71 |
| ADMIXTURE | SD | SLUDGE SOLID | 2.50 |
| FOR | | (RECYCLED POWDER) | |
| CONCRETE | | | |
| FINE | S | PIT SAND FROM KISARAZU | 2.62 |
| AGGREGATE | | (DESERT SAND) | (2.68) |
| | | (CRUSHED LIMESTONE) | (2.68) |
| COARSE | G1 | CRUSHED HARD SANDSTONE FROM OME 1005 | 2.65 |
| AGGREGATE | | (CRUSHED LIMESTONE 10 mm) | (2.69) |
| | G2 | CRUSHED HARD SANDSTONE FROM OME 2010 | 2.66 |
| | | (CRUSHED LIMESTONE 20 mm) | (2.69) |
| CHEMICAL | SP1 | HIGH-RANGE AIR-ENTRAINING | — |
| ADMIXTURE | | WATER REDUCING AGENT 1100NT | |
| FOR | | (HIGH-RANGE AIR-ENTRAINING | |
| CONCRETE | | WATER REDUCING AGENT VISCO CRETE 4100) | |
| | SP2 | HIGH-RANGE WATER REDUCING AGENT | — |
| | | 1200N IMPROVED | |
| | SP3 | AIR-ENTRAINING WATER REDUCING AGENT | — |
| | | SIKAMENT J OR JS | |
| | AE | AIR ENTRAINING AGENT AER5O | — |
| | SI | STRENGTH INCREASER: C × 0.2 or 2% | — |

Note:
product name and density in parentheses indicate those used for the Sample No. 11 mix proportion, to be described later.

Out of those in Table 1, ordinary portland cement (OPC), sulfate resistant portland cement (SR), silica fume <Elkem-Egypt> (SF1), silica fume <zirconia> (SF2), type-II fly ash <JISA6201> (FA1), type-I fly ash <JISA6201> (FA2), and ground granulated blast furnace slag (GGBS) correspond to the binder (B). And, calcium hydroxide (Ca(OH)₂) in calcium hydroxide solution (W2), anhydrite (CaSO₄), limestone powder (LSP), and strength increaser (SI) correspond to additive. Note that, anhydrite is a part of ground granulated blast furnace slag.

Table 2 shows the amount of material mixed in the present examples. Table 3 shows the principal ratios of each material mixed. The above materials were mixed as shown in Tables 2 and 3. Note that, percentage (%) in the “EXAMPLE NO” columns in Tables 2 and 3 indicate the ratio of the cement (OPC) or (SR) to the binders (OPC(SR)+SF+FA+GGBS).

Further, concrete including 40% of cement was used as the comparison example. The ratio (40%) of cement in this comparison example corresponds to the minimum ratio of cement usage in B-type portland blast furnace slag cement (JIS (Japan Industrial Standard) R 5211). In the C-type portland blast furnace slag cement, the minimum ratio of cement is 30% (the maximum ratio of slag is 70%). In the present example, this cement ratio is maintained at less than or equal to 30%. In other words, the amount of cement usage is minimized as much as possible.

TABLE 2

| | | UNIT AMOUNT (kg/m³) | | | | | | | | | | |
|---|---|---|---|---|---|---|---|---|---|---|---|---|
| EXAMPLE NO | | W1 | W2 | W3 | OPC | SR | SF1 | SF2 | FA1 | FA2 | GGBS | CaSO₄ |
| COMPARISON | | 138 | | | 148 | | | | | | 222 | |
| EXAMPLE | | | | | | | | | | | | |
| (40%) | | | | | | | | | | | | |
| 5% | 1 | | 150 | | 18 | | | 18 | 55 | | 268 | 8.3 |
| 8% | 2 | | 150 | | 29 | | | | 184 | | 150 | 4.6 |
| | 3 | | 150 | | 29 | | | | 184 | | 150 | 4.6 |
| | 4 | | 150 | | 29 | | | 74 | 111 | | 150 | 4.6 |
| 10% | 5 | | 110 | | 29 | | | | 59 | | 200 | 6.2 |
| | 6 | | 120 | | 29 | | | | 59 | | 200 | 6.2 |
| | 7 | | 110 | | 29 | | 15 | | 44 | | 200 | 6.2 |
| | 8 | | 120 | | 29 | | | | 59 | | 190 | 16.5 |
| | 9 | | 110 | | 29 | | 15 | | 44 | | 200 | 6.2 |
| 15% | 10 | | 120 | | 44 | | | | 59 | | 186 | 5.8 |
| | 11 | | 48 | 72 | 44 | | 7 | | 52 | | 186 | 5.7 |
| | 12 | | 120 | | 44 | | 7.4 | | 52 | | 186 | 5.7 |
| | 13 | | 130 | | 48 | | 8 | | 56 | | 201 | 6.2 |
| | 14 | | 140 | | 52 | | 8.6 | | 60 | | 217 | 6.7 |
| | 15 | | 130 | | 48 | | 8 | | 56 | | 201 | 6.2 |
| | 16 | | 130 | | 56 | | 9.3 | | 65 | | 234 | 7.2 |
| | 17 | | 130 | | 43 | | 7.2 | | 51 | | 182 | 5.6 |
| | 18 | | 130 | | 48 | | | 8 | 56 | | 201 | 6.2 |
| | 19 | | 130 | | | 48 | 8 | | 56 | | 201 | 6.2 |
| | 20 | 130 | | | 48 | | | 8 | | 56 | 201 | 6.2 |
| | 21 | 185 | | | 68 | | | 11.4 | 80 | | 287 | 8.9 |
| | 22 | 80 | | | 27 | | | 4.4 | 31 | | 112 | 3.5 |
| 20% | 23 | 110 | | | 59 | | | | 88 | | 143 | 4.4 |
| | 24 | 100 | | | 54 | | | | 80 | | 130 | 4.0 |
| | 25 | | 110 | | 59 | | | | 59 | | 172 | 5.3 |
| | 26 | | 120 | | 59 | | | | 59 | | 172 | 5.3 |
| | 27 | | 110 | | 59 | | 15 | | 44 | | 172 | 5.3 |
| | 28 | | 110 | | 59 | | | | 59 | | 172 | 5.3 |
| | 29 | | 110 | | 59 | | 7 | | 52 | | 172 | 5.3 |
| | 30 | | 120 | | 59 | | | | 59 | | 172 | 5.3 |
| | 31 | | 120 | | 59 | | 7 | | 52 | | 172 | 5.3 |
| 30% | 32 | 110 | | | 89 | | | | 59 | | 143 | 4.4 |
| | 33 | 110 | | | 89 | | 15 | | 44 | | 143 | 4.4 |
| | 34 | | 120 | | 89 | | | | 59 | | 143 | 4.4 |
| | 35 | | 120 | | 89 | | | | 59 | | 143 | 4.4 |

| | | UNIT AMOUNT (kg/m³) | | | | | | | | | |
|---|---|---|---|---|---|---|---|---|---|---|---|
| EXAMPLE NO | | LSP | SD | S | G1 | G2 | SP1 | SP2 | SP3 | AE | SI |
| COMPARISON | | | | 865 | 385 | 582 | | | 5.55 | | |
| EXAMPLE | | | | | | | | | | | |
| (40%) | | | | | | | | | | | |
| 5% | 1 | 1 | | 799 | 388 | 584 | 2.22 | | | 0.037 | |
| 8% | 2 | 1 | | 775 | 388 | 584 | 2.22 | | | 0.026 | |
| | 3 | 1 | | 775 | 388 | 584 | 2.03 | | | 0.055 | |
| | 4 | 1 | | 771 | 388 | 584 | 2.03 | | | 0.055 | |
| 10% | 5 | 75 | | 886 | 395 | 597 | 7.03 | | | | |
| | 6 | 57 | 18 | 873 | 389 | 588 | | | 11.10 | | 0.06 |
| | 7 | 57 | 18 | 885 | 394 | 596 | 5.00 | | | | |
| | 8 | 57 | 18 | 873 | 389 | 588 | 4.00 | | | | |
| | 9 | 57 | 18 | 885 | 394 | 596 | 5.00 | | | | 0.06 |
| 15% | 10 | 57 | 18 | 874 | 389 | 588 | 4.00 | | | | 0.89 |
| | 11 | 57 | 18 | 894 | 326 | 663 | 2.50 | | | | 0.09 |
| | 12 | 75 | | 877 | 388 | 584 | 3.70 | | | 0.074 | |
| | 13 | 51 | | 851 | 388 | 584 | 2.96 | | | 0.056 | |
| | 14 | 26 | | 826 | 388 | 584 | 2.40 | | | 0.037 | |
| | 15 | 51 | | 851 | 388 | 584 | 2.96 | | | 0.056 | |
| | 16 | | | 852 | 388 | 584 | 2.97 | | | 0.056 | |
| | 17 | 81 | | 851 | 388 | 584 | 2.77 | | | 0.056 | |
| | 18 | 51 | | 852 | 388 | 584 | 2.96 | | | 0.056 | |
| | 19 | 51 | | 852 | 388 | 584 | 2.96 | | | 0.037 | |
| | 20 | 51 | | 856 | 388 | 584 | 2.96 | | | 0.056 | |
| | 21 | | | 631 | 388 | 582 | | | | 0.032 | |
| | 22 | 192 | | 981 | 388 | 582 | 11.09 | | | 0.036 | |
| 20% | 23 | 75 | | 884 | 394 | 595 | | 5.92 | | | |
| | 24 | 82 | | 905 | 403 | 609 | | 5.18 | | | |
| | 25 | 57 | 18 | 887 | 395 | 597 | 4.50 | | | | |
| | 26 | 57 | 18 | 874 | 389 | 588 | 4.00 | | | | 1.18 |
| | 27 | 57 | 18 | 886 | 395 | 597 | 5.00 | | | | |
| | 28 | 57 | 18 | 887 | 395 | 597 | 6.00 | | | | 0.12 |
| | 29 | 57 | 18 | 886 | 395 | 597 | 5.50 | | | | 0.12 |
| | 30 | 57 | 18 | 874 | 389 | 588 | 4.00 | | | | 0.12 |
| | 31 | 57 | 18 | 874 | 389 | 588 | 4.50 | | | | 0.12 |
| 30% | 32 | 75 | | 888 | 396 | 598 | 6.66 | | | | |
| | 33 | 75 | | 888 | 396 | 598 | 6.66 | | | | |
| | 34 | 57 | 18 | 888 | 395 | 597 | 4.00 | | | | 1.77 |
| | 35 | 57 | 18 | 875 | 390 | 589 | 4.50 | | | | 0.18 |

TABLE 3

| | | RATIO (RATIO | | | | | | RATIO OF ADDITIVES | | | |
|---|---|---|---|---|---|---|---|---|---|---|---|
| | | TO BINDER: %) | | | | W/B | s/a | (RATIO TO BINDER: %) | | | |
| EXAMPLE NO | | OPC | SF | FA | GGBS | (%) | (%) | Ca(OH)₂ | CaSO₄ | LSP | SI |
| COMPARISON | | 40 | 0 | 0 | 60 | 37.3 | 47.6 | 0 | 0 | 0 | 0 |
| EXAMPLE (40%) | | | | | | | | | | | |
| 5% | 1 | 5 | 5 | 15 | 75 | 40.7 | 45.5 | 0.05 | 2.26 | 0.3 | 0 |
| 8% | 2 | 8 | 0 | 50 | 42 | 40.7 | 44.7 | 0.05 | 1.25 | 0.3 | 0 |
| | 3 | 8 | 0 | 50 | 42 | 40.7 | 44.7 | 0.05 | 1.25 | 0.3 | 0 |
| | 4 | 8 | 20 | 30 | 42 | 40.7 | 44.6 | 0.05 | 1.25 | 0.3 | 0 |
| 10% | 5 | 10 | 0 | 20 | 70 | 37.3 | 47.6 | 0.05 | 2.11 | 25.5 | 0 |
| | 6 | 10 | 0 | 20 | 70 | 40.7 | 47.6 | 0.05 | 2.11 | 19.4 | 0.02 |
| | 7 | 10 | 5 | 15 | 70 | 37.3 | 47.6 | 0.05 | 2.11 | 19.4 | 0 |
| | 8 | 10 | 0 | 20 | 70 | 40.7 | 47.6 | 0.06 | 5.60 | 19.4 | 0 |
| | 9 | 10 | 5 | 15 | 70 | 37.3 | 47.6 | 0.05 | 2.11 | 19.4 | 0.02 |
| 15% | 10 | 15 | 0 | 20 | 65 | 40.7 | 47.6 | 0.05 | 1.97 | 19.3 | 0.30 |
| | 11 | 15 | 2.5 | 17.5 | 65 | 40.7 | 47.6 | 0.05 | 1.93 | 19.3 | 0.03 |
| | 12 | 15 | 2.5 | 17.5 | 65 | 40.7 | 47.8 | 0.05 | 1.93 | 25.4 | 0 |
| | 13 | 15 | 2.5 | 17.5 | 65 | 40.7 | 47 | 0.05 | 1.94 | 16.0 | 0 |
| | 14 | 15 | 2.5 | 17.5 | 65 | 40.7 | 46.3 | 0.05 | 1.95 | 7.6 | 0 |
| | 15 | 15 | 2.5 | 17.5 | 65 | 40.7 | 47 | 0.05 | 1.94 | 16.0 | 0 |
| | 16 | 15 | 2.5 | 17.5 | 65 | 35 | 47 | 0.05 | 1.94 | 0 | 0 |
| | 17 | 15 | 2.5 | 17.5 | 65 | 45 | 47 | 0.06 | 1.94 | 28.1 | 0 |
| | 18 | 15 | 2.5 | 17.5 | 65 | 40.7 | 47 | 0.05 | 1.94 | 16.0 | 0 |
| | 19 | 15 | 2.5 | 17.5 | 65 | 40.7 | 47 | 0.05 | 1.94 | 16.0 | 0 |
| | 20 | 15 | 2.5 | 17.5 | 65 | 40.7 | 47.1 | 0 | 1.94 | 16.0 | 0 |
| | 21 | 15 | 2.5 | 17.5 | 65 | 40.7 | 39.7 | 0 | 1.97 | 0 | 0 |
| | 22 | 15 | 2.5 | 17.5 | 65 | 40.7 | 50.6 | 0 | 1.97 | 107.9 | 0 |
| 20% | 23 | 20 | 0 | 30 | 50 | 37.3 | 47.6 | 0 | 1.49 | 25.5 | 0 |
| | 24 | 20 | 0 | 30 | 50 | 37.3 | 47.6 | 0 | 1.49 | 30.6 | 0 |
| | 25 | 20 | 0 | 20 | 60 | 37.3 | 47.6 | 0.05 | 1.79 | 19.3 | 0 |
| | 26 | 20 | 0 | 20 | 60 | 40.7 | 47.6 | 0.05 | 1.79 | 19.3 | 0.40 |
| | 27 | 20 | 5 | 15 | 60 | 37.3 | 47.6 | 0.05 | 1.79 | 19.3 | 0 |
| | 28 | 20 | 0 | 20 | 60 | 37.3 | 47.6 | 0.05 | 1.79 | 19.3 | 0.04 |
| | 29 | 20 | 2.5 | 17.5 | 60 | 37.3 | 47.6 | 0.05 | 1.79 | 19.3 | 0.04 |
| | 30 | 20 | 0 | 20 | 60 | 40.7 | 47.6 | 0.05 | 1.79 | 19.3 | 0.04 |
| | 31 | 20 | 2.5 | 17.5 | 60 | 40.7 | 47.6 | 0.05 | 1.79 | 19.3 | 0.04 |
| 30% | 32 | 30 | 0 | 20 | 50 | 37.3 | 47.6 | 0 | 1.49 | 25.4 | 0 |
| | 33 | 30 | 5 | 15 | 50 | 37.3 | 47.6 | 0 | 1.49 | 25.4 | 0 |
| | 34 | 30 | 0 | 20 | 50 | 40.7 | 47.6 | 0.05 | 1.49 | 19.3 | 0.60 |
| | 35 | 30 | 0 | 20 | 50 | 40.7 | 47.6 | 0.05 | 1.49 | 19.3 | 0.06 |

In table 3, the water-binder ratio (W/B) is the ratio of water (W1+W2+W3) to binder (OPC+SF+FA+GGBS). And the fine aggregate ratio (s/a) is the volumetric ratio of fine aggregate (S) to aggregate (S+G1+G2). Note that, CaSO₄ is a part of GGBS.

### <Conditions for Manufacturing Concrete>

Table 4 shows the conditions for mixing concrete. Table 5 shows the conditions for manufacturing (mixing method) concrete.

TABLE 4

| | SAMPLE NO. | |
|---|---|---|
| | 1~4, 12~22 | 5~11, 23~35 |
| TARGET SLUMP | 21 ± 2 cm (12 ± 2.5) | 15 cm OR HIGHER |
| TARGET AIR CONTENT | 4.5 ± 1.5% | 4.50% |

TABLE 5

| | SAMPLE NO. | | |
|---|---|---|---|
| | 1~4, 12~22 | 5~10, 23~35 | 11 |
| MIXER USED | FORCED BIAXIAL MIXER | FORCED BIAXIAL MIXER | FORCED UNIAXIAL |
| | (CAPACITY 60 L) | (CAPACITY 60 L) | HORIZONTAL MIXER |
| | | | (CAPACITY 60 L) |
| MIXED | 60 L/BATCH | 60 L/BATCH | 50 L/BATCH |
| AMOUNT | | | |
| MIXING TIME | DRY MIXING | DRY MIXING | DRY MIXING |
| | 10 SECONDS | 10 SECONDS | 30 SECONDS |
| | AFTER (W + SP) INJECTION | AFTER (W + SP + SI) | AFTER CEMENT INJECTION |
| | 60 SECONDS | INJECTION | 60 SECONDS |
| | AFTER SCRAPING | 270 SECONDS | AFTER (W + SP + SI) |
| | 30 SECONDS | | INJECTION |
| | (210 SECONDS) | | 180 SECONDS |

### <Items Tested>

### (1) Test on Fresh Property of Concrete (Sample Nos. 1-35)

As a test on fresh property of concrete, slump, air content and temperature after mixing were measured. The testing method of slump and air content were performed in conformity with Japan Industrial Standard (JIS) A 1101 (BS 1881 Part 102), JIS A 1128 (BS 1881 Part 106), respectively. Additionally, concrete temperature was measured with a thermometer.

### (2) Compressive Strength Test (Sample Nos. 1-35)

Test specimen of 0100×200 mm (150×150×150 mm) was made, then compressive strength was measured after water curing at 20° C. (68.0° F.) (23° C. (73.4° F.)) and at 50° C. (122.0° F.) respectively in conformity with JIS A 1108 (BS EN 206)-(3) Drying Shrinkage Test (Sample Nos. 5-11, Sample Nos. 23-35)

Test specimen of 100×100×400 mm (75×75×285 mm) was made, and after underwater curing until 7 days of material age, shrinkage change (length change) due to drying was measured in conformity with JIS A 1129 (ASTM C 157).

[Note] the standards and dimensions in parentheses above were applied to Sample No. 11.

### <Test Results>

Test results on the fresh properties of concrete are shown in Table 6.

TABLE 6

| | | SLUMP | AIR CONTENT | TEMPERATURE |
|---|---|---|---|---|
| EXAMPLE NO. | | cm | % | ° C. |
| COMPARISON | | 4.5 | 2.3 | 21.5 |
| EXAMPLE | | | | |
| (40%) | | | | |
| 5% | 1 | 21.5 | 7.0→5.8 | 21.6 |
| 8% | 2 | 23.5 | 2.2 | 21.6 |
| | 3 | 21.0 | 3.6 | 22.0 |
| | 4 | 20.0 | 3.8 | 21.5 |
| 10% | 5 | 21.5 | 1.1 | 20.7 |
| | 6 | 22.0 | 2.1 | 22.3 |
| | 7 | 22.0 | 2.3 | 21.3 |
| | 8 | 20.5 | 2.1 | 21.9 |
| | 9 | 11.0 | 3.3 | 22.8 |
| 15% | 10 | 20.5 | 1.8 | 22.3 |
| | 11 | 24.5 | 2.9 | 25.0 |
| | 12 | 22.0 | 4.6 | 20.5 |
| | 13 | 21.5 | 5.2 | 20.8 |
| | 14 | 22.0 | 6.0 | 20.6 |
| | 15 | 22.0 | 5.3 | 20.9 |
| | 16 | 21.5 | 5.4 | 21.3 |
| | 17 | 19.5 | 5.5 | 21.0 |
| | 18 | 22.5 | 6.0 | 20.5 |
| | 19 | 22.5 | 6.0 | 20.6 |
| | 20 | 23.0 | 8.6→6.0 | 22.0 |
| | 21 | 20.5 | 1.5 | 19.3 |
| | 22 | 0 | 3.6 | 19.0 |
| 20% | 23 | 24.0 | 1.7 | 20.8 |
| | 24 | 20.0 | 2.5 | 20.8 |
| | 25 | 9.0 | 3.1 | 22.9 |
| | 26 | 18.5 | 2.1 | 22.6 |
| | 27 | 17.0 | 2.9 | 23.4 |
| | 28 | 18.5 | 2.5 | 22.7 |
| | 29 | 15.0 | 2.8 | 22.9 |
| | 30 | 8.0 | 2.8 | 22.9 |
| | 31 | 13.5 | 2.5 | 23.4 |
| 30% | 32 | 22.0 | 2.4 | 21.1 |
| | 33 | 22.0 | 2.2 | 21.0 |
| | 34 | 16.5 | 2.5 | 23.0 |
| | 35 | 16.0 | 2.0 | 23.1 |

As shown in Table 6, whereas the slump value in the case of the comparison example is smaller than the target value (15 cm, 21±2 cm), among the present examples, those of (Sample Nos. 1-4, Sample Nos. 12-22) are almost all within the range of the target value, and those of (Sample Nos. 5-11, Sample Nos. 23-25) almost all exceed the target value. In other words, the present examples show better workability than the comparison example. And the results on air content and temperature were almost the same with the comparison example.

The comparison result between Sample No. 15 and Sample No. 18 showed that, silica fume derived from zirconia achieves a higher slump value than standard silica fume (derived from metallic silicon or ferrosilicon), as silica fume. The comparison result between Sample No. 15 and Sample No. 19 showed that sulfate resistant portland cement achieves a higher slump value than ordinary portland cement, as cement. The comparison result between Sample No. 15 and Sample No. 20 showed that, type-I fly ash specified in JISA6201 has better fluidity than type-II fly ash specified in JISA6201, as fly ash.

Next, results on the compressive strength test are shown in Table 7.

TABLE 7

| | | | | | | | 50° C. COMPRESSIVE | | |
|---|---|---|---|---|---|---|---|---|---|
| | | 20° C. COMPRESSIVE STRENGTH | | | | | STRENGTH | | |
| | | (N/mm² (MPa)) | | | | | (N/mm² (MPa)) | | |
| EXAMPLE NO | | 1 DAY | 3 DAYS | 7 DAYS | 28 DAYS | 56 DAYS | 7 DAYS | 14 DAYS | 28 DAYS |
| COMPARISON | | 6.39 | 23.0 | 36.0 | 58.5 | — | 71.0 | — | 78.9 |
| EXAMPLE(40%) | | | | | | | | | |
| 5% | 1 | — | — | 11.6 | 16.6 | — | — | — | — |
| 8% | 2 | — | — | — | — | — | — | — | — |
| | 3 | — | — | 11.6 | 17.9 | — | — | — | — |
| | 4 | — | — | 13.0 | 19.8 | — | — | — | — |
| 10% | 5 | 7.92 | 18.5 | 24.6 | 32.1 | — | 29.1 | — | 33.5 |
| | 6 | 5.86 | 22.7 | 31.4 | 45.0 | — | 37.2 | — | 43.6 |
| | 7 | 9.26 | 21.2 | 28.0 | 39.7 | — | 42.2 | — | 53.6 |
| | 8 | 12.40 | 22.7 | 27.5 | 34.5 | — | 31.9 | — | 38.1 |
| | 9 | 10.20 | 26.2 | 35.1 | 47.4 | — | — | 51.7 | 55.7 |
| 15% | 10 | 6.34 | 28.1 | 41.5 | 57.4 | — | 48.7 | — | 53.3 |
| | 11 | 13.30 | 31.2 | 42.3 | 50.2 | — | — | — | — |
| | 12 | — | — | — | 31.2 | — | — | — | — |
| | 13 | — | — | — | 30.2 | — | — | — | — |
| | 14 | — | — | — | 28.6 | — | — | — | — |
| | 15 | — | — | 19.2 | 26.8 | 30.4 | — | — | — |
| | 16 | — | — | 22.5 | 27.9 | 31.7 | — | — | — |
| | 17 | — | — | 18.7 | 24.9 | 27.3 | — | — | — |
| | 18 | — | — | 23.9 | 33.2 | 36.4 | — | — | — |
| | 19 | — | — | 23.1 | 31.6 | 34.8 | — | — | — |
| | 20 | — | — | 23.1 | 31.3 | — | — | — | — |
| | 21 | — | — | 19.9 | 30.1 | — | — | — | — |
| | 22 | — | — | 14.0 | 20.5 | — | — | — | — |
| 20% | 23 | 3.11 | 16.8 | 26.2 | 33.5 | — | 35.9 | — | 41.5 |
| | 24 | 4.28 | 17.4 | 25.9 | 35.0 | — | 33.0 | — | 38.3 |
| | 25 | 7.30 | 29.0 | 40.9 | 56.1 | — | 51.1 | — | 55.8 |
| | 26 | 5.07 | 28.4 | 46.1 | 63.5 | — | 55.9 | — | 59.1 |
| | 27 | 8.54 | 29.5 | 42.1 | 57.9 | — | 60.5 | — | 67.8 |
| | 28 | 9.24 | 32.4 | 45.5 | 63.2 | — | — | 63.4 | 68.2 |
| | 29 | 8.86 | 31.4 | 44.9 | 60.6 | — | — | 65.6 | 69.7 |
| | 30 | 6.80 | 25.8 | 36.7 | 51.3 | — | — | 48.5 | 51.6 |
| | 31 | 7.69 | 28.0 | 37.6 | 52.8 | — | — | 53.9 | 57.8 |
| 30% | 32 | 7.05 | 25.4 | 39.9 | 54.1 | — | 55.8 | — | 63.4 |
| | 33 | 6.96 | 29.7 | 45.4 | 62.5 | — | 70.1 | — | 76.7 |
| | 34 | 5.17 | 29.3 | 53.0 | 69.4 | — | 68.8 | — | 75.2 |
| | 35 | 7.78 | 27.9 | 44.2 | 64.3 | — | — | 68.6 | 75.6 |

As shown in Table 7, among the present examples, compressive strengths close to that of the comparison example were achieved when the cement ratio was greater than or equal to 10% even though the usage of cement was less than the comparison example. Particularly, favorable compressive strengths were achieved in the cases where the cement ratios ranged from 10% to 20%. Further, even when the cement ratio was less than 10%, compressive strengths greater than or equal to 16 N/mm² (MPa) were achieved, which are lower than that of the comparison example. And the compressive strengths at 20° C. (68.0° F.) (23° C. (73.4° F.)) of the present examples (Sample Nos. 1-35) at 28-day material age ranged from 16.6 N/mm² (MPa) to 69.4 N/mm² (MPa).

Also, the comparison result between Sample No. 15 and Sample No. 18 showed that, silica fume derived from zirconia achieves higher compressive strength than standard silica fume (derived from metallic silicon or ferrosilicon), as silica fume. The comparison result between Sample No. 15 and Sample No. 19 showed that sulfate resistant portland cement achieves higher compressive strength than ordinary portland cement, as cement. [Note] the temperatures in parentheses above were applied to Sample No. 11.

Next, results on the drying shrinkage test for Sample Nos. 5-11 and Sample Nos. 23-35 are shown in Table 8.

TABLE 8

| | | LENGTH CHANGE (×10⁻⁶) | | | | | | |
|---|---|---|---|---|---|---|---|---|
| SAMPLE NO. | | 0 DAYS | 1 DAY | 3 DAYS | 7 DAYS | 14 DAYS | 21 DAYS | 28 DAYS |
| 40% | | 0 | −134 | −236 | −323 | −397 | −439 | −503 |
| (COMPARISON | | | | | | | | |
| EXAMPLE) | | | | | | | | |
| 10% | 5 | 0 | −51 | −83 | −111 | −194 | −217 | −259 |
| | 6 | 0 | −23 | −125 | −190 | −260 | −306 | −348 |
| | 7 | 0 | −28 | −125 | −181 | −246 | −292 | −334 |
| | 8 | 0 | −65 | −79 | −111 | −172 | −223 | −302 |
| | 9 | 0 | −46 | −88 | −195 | −246 | −325 | −348 |
| 15% | 10 | 0 | −88 | −148 | −204 | −278 | −310 | −380 |
| | 11 | 0 | −70 | — | −120 | −140 | — | −170 |
| 20% | 23 | 0 | −28 | −74 | −111 | −185 | −236 | −250 |
| | 24 | 0 | −28 | −83 | −125 | −190 | −259 | −297 |
| | 25 | 0 | −51 | −111 | −181 | −255 | −288 | −348 |
| | 26 | 0 | −61 | −130 | −181 | −279 | −307 | −386 |
| | 27 | 0 | −79 | −130 | −172 | −269 | −334 | −385 |
| | 28 | 0 | −56 | −139 | −227 | −292 | −343 | −375 |
| | 29 | 0 | −83 | −129 | −213 | −268 | −337 | −374 |
| | 30 | 0 | −83 | −148 | −194 | −254 | −341 | −387 |
| | 31 | 0 | −60 | −111 | −171 | −250 | −333 | −370 |
| 30% | 32 | 0 | −46 | −111 | −162 | −241 | −282 | −287 |
| | 33 | 0 | −74 | −134 | −167 | −245 | −278 | −296 |
| | 34 | 0 | −60 | −139 | −227 | −278 | −353 | −418 |
| | 35 | 0 | −102 | −153 | −232 | −302 | −371 | −418 |

Negative values of length change in Table 8 indicate that the length had shortened with regard to the original length. On the contrary, positive values indicate that the length had extended.

As shown in Table 8, the length changes due to drying (shrinkage amount) of the present examples are smaller than the comparison example. In other words, it can be said that the present examples are less liable to cracks than the comparison example.

As mentioned above, usage of cement that emits a large amount of carbon dioxide was reduced as much as possible and the usage of mineral admixture for concrete (binders) that emits lesser amounts of carbon dioxide was increased in the present examples.

To be specific, the ratio of cement to binders was maintained at a range from 5% to 30%, silica fume from 0% to 20%, fly ash from 0% to 50%, blast furnace slag from 42% to 75% and water content per unit volume of concrete from 80 to 185 kg/m³. Further, at least one kind of additive out of calcium hydroxide (Ca(OH)₂) being an alkaline component, gypsum (CaSO₄), strength increaser (SI) and limestone powder (LSP) was mixed. Meanwhile, gypsum is apart of blast furnace slag.

Additionally, concrete was composed of aggregate including fine aggregate and coarse aggregate, water and chemical admixture for concrete such as a high-range air-entraining water reducing agent.

In this way, concrete emitting a small amount of carbon dioxide during production but exhibiting excellent fresh properties of concrete and high strength can be achieved.

In the examples described above, description on cement composition was given taking concrete as an example however, cement composition may be cement paste not including fine aggregate and coarse aggregate as aggregate, or mortar not including coarse aggregate.

### <Method of Producing Concrete>

As explained above, the composition for concrete capable of reducing carbon dioxide emissions as well as developing high strength has been made clear. The composition of such concrete may be, for example as the silica fume shown in Table 3, of an extremely small amount compared with the other materials and the ratio thereof including in the binder being 2.5% of the entirety.

As above, when material of an extremely small amount to be mixed is included in the material to be mixed, there may be a case where the particular material is not mixed properly depending on the way mixing is conducted. For example, in the case materials to be mixed are delivered through a narrow tube connected into the mixer when each of them are directly injected into the mixer, there is a possibility that the material of an extremely small amount would stick on the inner perimeter of the narrow tube, consequently few of that material would be delivered into the mixer. Thereupon, description will be given on a method for producing concrete, as in the present invention, having mixed therein several materials, being appropriate for a case where a material of an extremely small amount to be mixed is included, and further being capable of reducing carbon dioxide emissions, developing high strength and securing quality as well.

The method for producing concrete of the present invention appropriate for concrete capable of reducing carbon dioxide emissions, developing high strength and securing quality as well, consists of mixing in advance (premixes) binders to be mixed with water, aggregate and the like before mixing with a mixer.

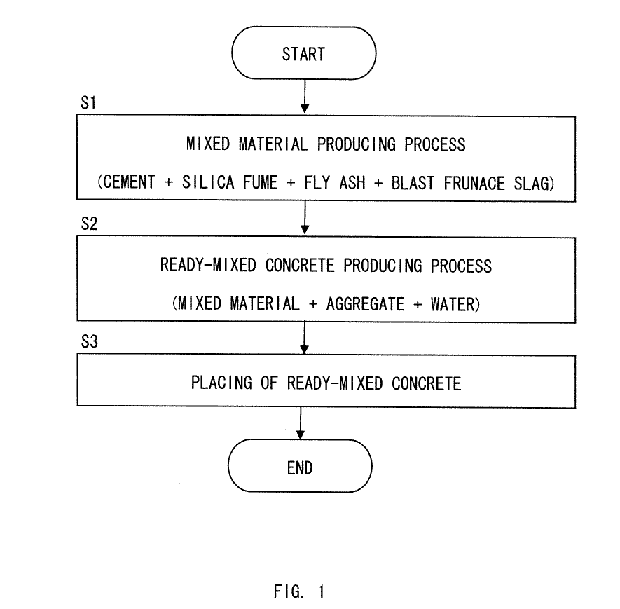

Specifically, using sample No. 1 of Table 3 as an example, 5 parts by weight of cement, 5 parts by weight of silica fume, 15 parts by weight of fly ash and 75 parts by weight of blast furnace slag were measured and mixed to make up 100 parts by weight of binder, which is mixed in advance at plants and the like, as shown in FIG. 1 (mixed material producing process S1).

Then, taking the mixed binder as 100, water of an amount corresponding to 40.7, aggregate whose ratio of fine aggregate is 45.5 are measured and injected into a mixer to be mixed in the mixer to produce ready-mixed concrete (ready-mixed concrete producing process S2).

Then the produced ready-mixed concrete is placed into forms to produce concrete members (ready-mixed concrete placing process S3).

With such method for producing concrete, since cement, silica fume, and fly ash of extremely small amounts included in the binder are premixed with blast furnace slag of a relatively large amount, even though cement, silica fume, and fly ash are of extremely small amounts, an appropriate amount of cement, silica fume and fly ash can be certainly mixed in concrete. Therefore, concrete that is obliged to be added an extremely small amount of a predetermined material and for example capable of reducing carbon dioxide emissions, developing high strength and securing quality as well, can be easily produced. At this time, when the cement includes gypsum, strength of the concrete produced can be further developed. Additionally, by having mixed therein a chemical admixture for concrete (AD), the strength can be further developed. Since the amount of the chemical admixture for concrete (AD) included in concrete is extremely small, it is preferable that the chemical admixture for concrete is injected after mixing with the other materials and aggregate, similar to the materials of the binder.

Further, as described above, by using mixed material that has premixed therein several materials before mixing in the mixer, reduces the number of materials to be mixed in the mixer, thus allows to reduce the number of containers for storing the materials as well as eases the management of the materials. Furthermore, since the number of materials mixed is small, work at ready-mixed concrete plants can be simplified and also the use of much homogeneously mixed material allows the strength of concrete to develop much higher.

The method of producing concrete described above, uses a binder made by premixing cement, silica fume, fly ash and blast furnace slag however, the method does not necessarily need to include the above four types of material. For example, mixed material made by premixing 5-30 parts by weight of cement with at least one type of material selected from three types of material being 0-20 parts by weight of silica fume, 0-50 parts by weight of fly ash and 42-75 parts by weight of blast furnace slag can be used as the binder.

Further, a binder made by mixing cement with one type of material selected from three types of material being silica fume, fly ash, and blast furnace slag, and any one of the remainder not used for mixing or all of the remaining material can be mixed together with water and aggregate when mixing in the mixer.

Furthermore, mixed material made by premixing aggregate in addition to cement, silica fume, fly ash and blast furnace slag, can be used. For example, mixed material made by mixing sand as fine aggregate out of aggregates, and one or more types of material selected from cement, silica fume, fly ash and blast furnace slag may be prepared to be mixed with water in a mixer. As shown in Table 2, the amount of aggregate mixed is larger than that of the other materials. Therefore, mixing with other materials, at least one type of material of the four types of material in a state mixed with aggregate, allows approximately homogeneous premixing even if an extremely small amount of a predetermined material is included. At this time, it is preferable that this material of an extremely small amount is mixed with fine aggregate out of aggregates, as described above.

As explained above, mixed material capable of being used as a binder can be produced by mixing at least two types of material selected from several materials of a proportion appropriate for producing cement composition capable of reducing carbon dioxide emissions, developing high strength and securing quality as well. Further, the mixed binder includes at least two types of material selected from cement, silica fume, fly ash, blast furnace slag, aggregate and the like of amounts appropriate for producing cement composition capable of reducing carbon dioxide emissions, developing high strength and securing quality as well, thus does not require containers such as silos for separately storing all the materials. Therefore, storage space and the cost can be saved. Further, mixed material having premixed at least two types of materials selected from cement, silica fume, fly ash, blast furnace slag, aggregate and the like can be premixed at plants and the like. For such reason, materials can be accurately measured by use of equipment at the plants and the like allowing provision of binders that is versatile, that secures high quality and retains uniform quality compared with the case where all the materials are mixed at ready-mixed concrete plants.

Additionally, the use of premixed binders makes it possible to reduce the mixing time at ready-mixed concrete plants. And further, with such mixed material, mixed material suitable for not only binders but suitable as, for example, mixed material to be mixed with soil for soil improvement can be produced.

The embodiment above has been described on an example where cement was included in a material however, at least two types of material selected from three types of material being 0-20 parts by weight of silica fume, 0-50 parts by weight of fly ash and 42-75 parts by weight of blast furnace slag may be mixed. A mixed material produced by such method is capable of producing cement composition by mixing 5-30 parts by weight of cement, aggregate and water, and also capable of being used for soil improvement by mixing with soil together with cement.

The examples described above are for facilitating the understanding of the present invention and is not intended to limit the present invention. Needless to say, the present invention may be modified or improved without departing from the spirit of the present invention, and includes equivalents thereof.

1. Cement composition comprising:
100 parts by weight of binder (B) including,
5-30 parts by weight of cement,
0-20 parts by weight of silica fume,
0-50 parts by weight of fly ash, and
42-75 parts by weight of blast furnace slag;
water (W) equivalent to 80-185 kg/m³ of water content per unit volume of concrete;
aggregate (A); and
chemical admixture for concrete (AD).

2. The cement composition according to claim 1, wherein the water (W) is 100-150 kg/m³ of water content per unit volume of concrete.

3. The cement composition according to claim 1, wherein a cement content per unit volume of concrete is 18-89 kg/m³.

4. The cement composition according to claim 1, wherein the cement is of 5-20 parts by weight and the fly ash is of 5-50 parts by weight.

5. The cement composition according to claim 1, wherein the cement is of 5-15 parts by weight.

6. The cement composition according to claim 1, wherein a water-binder ratio (W/B), which is a weight ratio of the water (W) to the binder (B), is greater than or equal to 35% and less than or equal to 45%.

7. The cement composition according to claim 1, wherein 28-day standard water curing compressive strength ranges from 16 N/mm² to 70 N/mm².

8. The cement composition according to claim 1, wherein the cement composition includes one or more types of additive selected from a group consisting of alkaline component, gypsum, tri-isopropanolamine, and limestone powder.

9. The cement composition according to claim 8, wherein the alkaline component is calcium hydroxide.

10. The cement composition according to claim 9, wherein a weight ratio of the calcium hydroxide to the binder (B) is less than 0.1%.

11. The cement composition according to claim 8, wherein the gypsum is natural anhydrite.

12. The cement composition according to claim 8, wherein a weight ratio of the gypsum to the binder (B) is greater than or equal to 1.2% and less than or equal to 6.0%.

13. The cement composition according to claim 8, wherein a weight ratio of the limestone powder to the binder (B) is greater than or equal to 0.3% and less than or equal to 108.0%.

14. The cement composition according to claim 8, wherein a weight ratio of the tri-isopropanolamine to the binder (B) is less than 1.0%.

15. The cement composition according to claim 1, wherein the silica fume is silica fume derived from zirconia.

16. The cement composition according to claim 1, wherein the fly ash is fly ash that satisfies the values which are specified for type-I fly ash of JIS (Japan Industrial Standard) A6201.

17. The cement composition according to claim 1, wherein the cement is sulfate resistant portland cement.

18. A method for producing mixed material comprising:
100 parts by weight of mixed material by mixing
5-30 parts by weight of cement,
0-20 parts by weight of silica fume,
0-50 parts by weight of fly ash, and
42-75 parts by weight of blast furnace slag.

19. A method for producing mixed material comprising:
mixed material by mixing
5-30 parts by weight of cement and
at least one type of material selected from three types of material being 0-20 parts by weight of silica fume, 0-50 parts by weight of fly ash, and 42-75 parts by weight of blast furnace slag.

20. The method for producing mixed material comprising:
mixing mixed material produced by the method for producing mixed material according to claim 18 and aggregate.

21. A method for producing mixed material including at least one type of material selected from four types of material being 5-30 parts by weight of cement, 0-20 parts by weight of silica fume, 0-50 parts by weight of fly ash, and 42-75 parts by weight of blast furnace slag comprising:
premixing at least one type of material with aggregate when the mixed material includes the one type of material selected from the four types of materials; and
premixing the material whose amount to be mixed is smaller of two or more types of material with the material whose amount is larger or with the aggregate, when the mixed material includes the two or more types of the material selected from the four types of material.

22. The method for producing mixed material according to claim 18, wherein the cement is 5-20 parts by weight and the fly ash is 5-50 parts by weight.

23. The method for producing mixed material according to claim 18, wherein the cement is 5-15 parts by weight.

24. A method for producing mixed material comprising:
mixing at least two types of material selected from four types of material being 5-30 parts by weight of cement, 0-20 parts by weight of silica fume, 0-50 parts by weight of fly ash and 42-75 parts by weight of blast furnace slag.

25. A method for producing mixed material comprising:
mixing at least two types of material selected from three types of material being 0-20 parts by weight of silica fume, 0-50 parts by weight of fly ash and 42-75 parts by weight of blast furnace slag.

26. The method for producing cement composition comprising:
mixing mixed material produced by the method for producing mixed material according to claim 18 and water (W).

27. The method for producing cement composition according to claim 26, wherein the water (W) corresponding to 80-185 kg/m³ of water content per unit volume of concrete is mixed.

28. The method for producing cement composition according to claim 26, wherein the water (W) is 100-150 kg/m³ of water content per unit volume of concrete.

29. The method for producing cement composition according to claim 27, wherein a cement content per unit volume of concrete is 18-89 kg/m³.
